(19) United States
(12) Patent Application Publication
(10) Pub. No.: US 2026/0078785 A1
(43) Pub. Date: Mar. 19, 2026

(54) CAPTIVE FASTENER SYSTEM

(71) Applicant: The Boeing Company, Arlington, VA (US)

(72) Inventors: Chase Armstrong, South Roxana, IL (US); James L. Davis, O'Fallon, MO (US)

(21) Appl. No.: 18/890,186

(22) Filed: Sep. 19, 2024

(51) Int. Cl. F16B 7/04; H02G 3/04

(52) U.S. Cl. CPC F16B 7/0426; F16B 7/0433; H02G 3/0406; H02G 3/0468

(57) ABSTRACT

A captive fastener system and methods of installing captive fasteners are presented. A captive fastener system comprises an expandable opening with an initial diameter connected to a channel; and the channel. The channel has an internal diameter larger than the initial diameter and an exit diameter configured to retain a head of a fastener inside the channel.

### CROSS-REFERENCE TO RELATED APPLICATION

This application is related to the following U.S. Patent Application entitled “Manifold for Connecting Corrugated Conduit,” Ser. No. ______, attorney docket no. 24-0492-US-NP, filed even date hereof, assigned to the same assignee, and incorporated herein by reference in its entirety.

### BACKGROUND INFORMATION

### 1. Field

The present disclosure relates generally to connecting structures and more specifically to captive fastener systems for joining structures.

### 2. Background

Loose fasteners can present potential foreign object debris (FOD) in assembly and maintenance. Foreign object debris (FOD) can cause undesirable effects to structures or personnel.

Therefore, it would be desirable to have a method and apparatus that takes into account at least some of the issues discussed above, as well as other possible issues. For example, it would be desirable to present methods and apparatus for securing fasteners in structures.

### SUMMARY

An embodiment of the present disclosure provides a captive fastener system. The captive fastener system comprises an expandable opening with an initial diameter connected to a channel, and the channel. The channel has an internal diameter larger than the initial diameter and an exit diameter configured to retain a head of a fastener inside the channel.

An embodiment of the present disclosure provides a method of installing a captive fastener. A shank of a fastener is placed through an expandable opening and into a channel of a structure. A head of the fastener is pressed through the expandable opening. The head of the fastener is retained within the channel by features of the channel.

An embodiment of the present disclosure provides a captive fastener system. The captive fastener system comprises a fastener with a head positioned within a channel, and the channel. The channel has an expandable opening configured to allow entry of the head of the fastener and limit exit of the head of the fastener and an exit diameter configured to allow a shaft of the fastener to extend through the exit diameter and prevent exit of the head of the fastener.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of a block diagram of a manufacturing environment in accordance with an illustrative embodiment;

FIG. 3 is an illustration of fibers extending through corrugated conduits and manifolds in accordance with an illustrative embodiment;

FIG. 4 is an illustration of an isometric view of a manifold and adapters in accordance with an illustrative embodiment;

FIG. 5 is an illustration of a partially exploded side view of a manifold and adapters in accordance with an illustrative embodiment;

FIG. 6 is an illustration of an exploded isometric view of a manifold and adapters in accordance with an illustrative embodiment;

FIG. 7 is an illustration of a side view of multiple adapters in accordance with an illustrative embodiment;

FIG. 8 is an illustration of a bottom view of a manifold with anti-rotation features in accordance with an illustrative embodiment;

FIG. 9 is an illustration of an exploded isometric view of a manifold and adapters in accordance with an illustrative embodiment;

FIG. 10 is an illustration of a side view of a fastener prior to installation as a captive fastener in accordance with an illustrative embodiment;

FIG. 11 is an illustration of a cross-sectional view of a fastener prior to installation as a captive fastener in a channel in accordance with an illustrative embodiment;

FIG. 12 is an illustration of a cross-sectional view of a captive fastener within a channel in accordance with an illustrative embodiment;

FIG. 13 is an illustration of a view of a structure with a captive fastener within a channel in accordance with an illustrative embodiment;

FIG. 14 is an illustration of a block diagram of a manufacturing environment in accordance with an illustrative embodiment;

FIG. 15 is a flowchart of a method of managing fibers in accordance with an illustrative embodiment;

FIG. 16 is a flowchart of a method of installing a captive fastener in accordance with an illustrative embodiment;

FIG. 17 is an illustration of an aircraft manufacturing and service method in a form of a block diagram in accordance with an illustrative embodiment; and

FIG. 18 is an illustration of an aircraft in a form of a block diagram in which an illustrative embodiment may be implemented.

### DETAILED DESCRIPTION

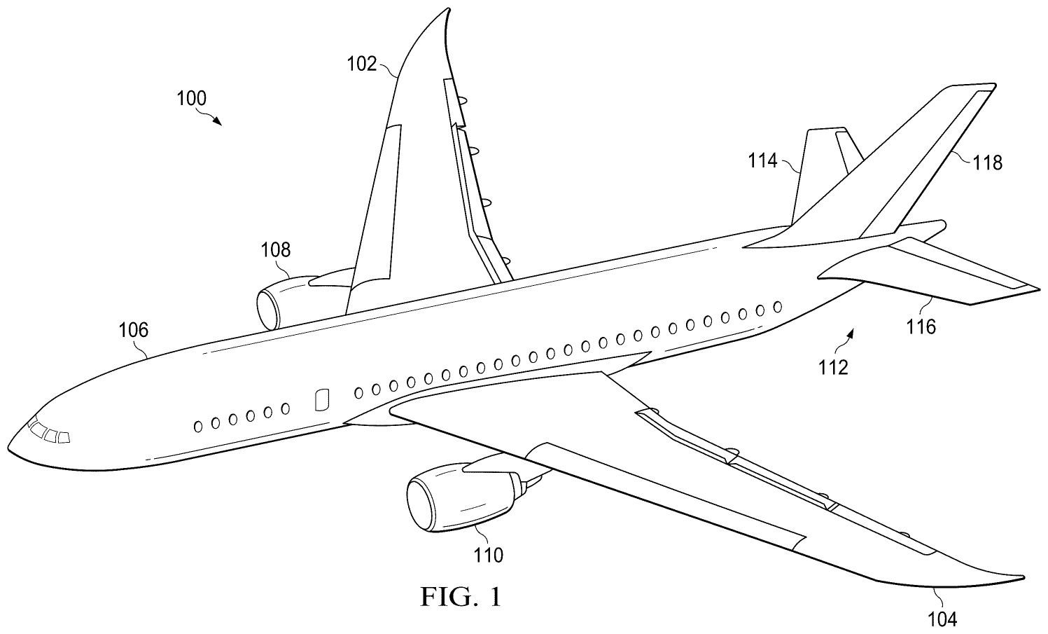

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

Aircraft 100 is an example of an aircraft that can have fibers to be managed. In some illustrative examples, systems of aircraft 100 can be joined together using captive fastener systems.

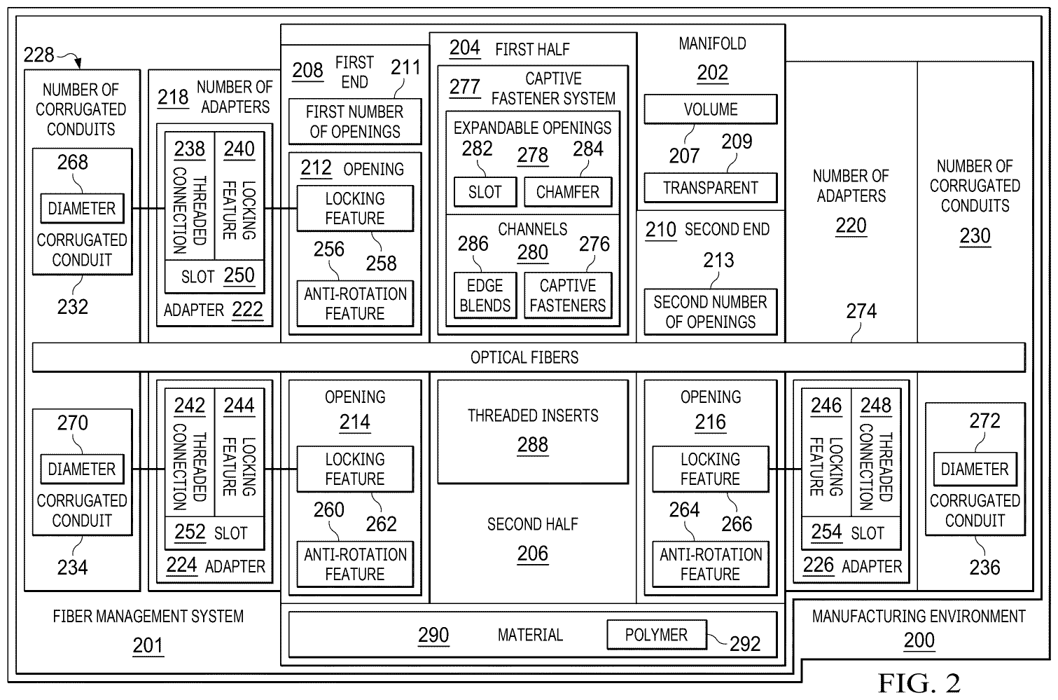

Turning now to FIG. 2, an illustration of a block diagram of a manufacturing environment is depicted in accordance with an illustrative embodiment. Fiber management system 201 can be created in manufacturing environment 200. Fiber management system 201 can be utilized in manufacturing environment 200.

Manifold 202 is configured to connect corrugated conduits. In this illustrative example, manifold 202 connects number of corrugated conduits 228 and number of corrugated conduits 230. Manifold 202 comprises first half 204, second half 206 removably connected to first half 204 to form volume 207 within manifold 202, first number of openings 211 on first end 208 to access volume 207, and second number of openings 213 on second end 210 to access volume 207. Removing first half 204 from second half 206 cleaves each of first number of openings 211 and each of second number of openings 213.

In this illustrative example, first number of openings 211 comprises a different quantity of openings from second number of openings 213. A quantity of openings on each end of first end 208 and second end 210 corresponds to a respective quantity of corrugated conduits to be connected to each of first end 208 and second end 210. In this illustrative example, first number of openings 211 comprises two openings, opening 212 and opening 214. In this illustrative example, second number of openings 213 comprises one opening, opening 216. In this illustrative example, number of corrugated conduits 228 connected to first end 208 of manifold 202 comprises two corrugated conduits, corrugated conduit 232 and corrugated conduit 234. In this illustrative example, number of corrugated conduits 230 connected to second end 210 of manifold 202 comprises one corrugated conduit, corrugated conduit 236. In this illustrative example, manifold 202 can be described as a 2:1 manifold.

First number of openings 211 comprises locking features configured to retain an adapter. In this illustrative example, opening 212 comprises locking feature 258 and opening 214 comprises locking feature 262. Locking feature 258 is configured to retain adapter 222. Locking feature 258 interacts with locking feature 240 to retain adapter 222. Locking feature 258 and locking feature 240 are non-threaded. Locking feature 262 is configured to retain adapter 224. Locking feature 262 interacts with locking feature 244 to retain adapter 224. Locking feature 262 and locking feature 244 are non-threaded.

Second number of openings 213 comprises locking features configured to retain an adapter. In this illustrative example, opening 216 comprises locking feature 266. Locking feature 266 is configured to retain adapter 226. Locking feature 266 interacts with locking feature 246 to retain adapter 226. Locking feature 266 is non-threaded.

In this illustrative example, the locking features are present on both first half 204 and second half 206. In some illustrative examples, the locking features are operational when first half 204 and second half 206 are removably connected. In some illustrative examples, the locking features comprise a series of grooves.

In some illustrative examples, first number of openings 211 comprises an anti-rotation feature. In this illustrative example, opening 212 comprises anti-rotation feature 256 and opening 214 comprises anti-rotation feature 260. In this illustrative example, opening 216 comprises anti-rotation feature 264. Anti-rotation features can comprise a protrusion configured to interaction with a respective adapter.

In some illustrative examples, number of adapters 218 comprise slots. As depicted, anti-rotation feature 256 interacts with slot 250 in adapter 222. As depicted, anti-rotation feature 260 interacts with slot 252 in adapter 224. As depicted, anti-rotation feature 264 interacts with slot 254 in adapter 226. The anti-rotation features are configured to restrict movement of respective adapters.

Each of slot 250, slot 252, and slot 254 can allow for fibers to be inserted into fiber management system 201 without separating manifold 202. In some illustrative examples, slot 250, slot 252, and slot 254 act as keying features. In some illustrative examples, anti-rotation feature 256, anti-rotation feature 260, and anti-rotation feature 264 act as keying features.

In some illustrative examples, slot 250, slot 252, and slot 254 can reduce compression on each respective adapter. Slot 250, slot 252, and slot 254 can allow for manifold 202 to compress a respective adapter to hold the respective adapter within manifold 202 without undesirably damaging the respective adapter.

Material 290 of manifold 202 is selected to allow for desired operations of fiber management system 201. In some illustrative examples, material 290 of manifold 202 is selected based on an operational environment for fiber management system 201. In some illustrative examples, material 290 of manifold 202 is selected based on weight. In some illustrative examples, material 290 is selected to enable at least one of inspection, maintenance, or operation. In some illustrative examples, material 290 of manifold 202 is selected to allow stray beams of light from broken fiber to be visually detected. In some illustrative examples, material 290 is selected to allow for inspection of optical fibers 274 in manifold 202. In some illustrative examples, manifold 202 comprises polymer 292. In some illustrative examples, polymer 292 is at least one of transparent 209 or translucent.

In some illustrative examples, material 290 of manifold 202 is a non-frangible material. In some illustrative examples, material 290 of manifold 202 is a material selected to reduce or prevent shattering of manifold 202. In some illustrative examples, material 290 of manifold 202 provides sufficient flexibility for fastening. In some illustrative examples, material 290 of manifold 202 is sufficiently compliant to allow for captive fasteners 276 to be sent through expandable openings 278. In this illustrative example, manifold 202 comprises captive fastener system 277. Captive fastener system 277 retains captive fasteners 276 to reduce foreign object debris. In some illustrative examples, captive fastener system 277 comprises an expandable opening with an initial diameter within one of the first half or the second half, wherein the expandable opening is connected to a channel, and wherein the channel within the first half or the second half has an internal diameter larger than the initial diameter and an exit diameter configured to retain a head of a fastener inside the channel.

In this illustrative example, expandable openings 278 are present in first half 204 of manifold 202. To restrain captive fasteners 276, captive fasteners 276 are sent through expandable openings 278. In some illustrative examples, each of expandable openings 278 comprises slot 282 and chamfer 284. A respective slot allows for captive fasteners 276 to enter through expandable openings 278. Edge blends 286 within channels 280 can aid in retention of captive fasteners 276. Edge blends 286 within channels 280 can allow for intentional removal of captive fasteners 276 from channels 280.

To secure first half 204 to second half 206 of manifold 202, captive fasteners 276 are fastened to second half 206. In some illustrative examples, captive fasteners 276 are secured to threaded inserts 288 in second half 206. In other illustrative examples, captive fasteners 276 are secured to threads in second half 206.

Fiber management system 201 comprises manifold 202, number of corrugated conduits 228, number of corrugated conduits 230, number of adapters 218 connecting number of corrugated conduits 228 to first end 208 of manifold 202, and number of adapters 220 connecting number of corrugated conduits 230 to second end 210 of manifold 202. Each of number of adapters 218 comprises a threaded connection and a non-threaded locking feature. Each of number of adapters 220 comprises a threaded connection and a non-threaded locking feature.

In some illustrative examples, at least one adapter of number of adapters 218 comprises a threaded connection with a diameter different than another adapter. In this illustrative example, adapter 222 has threaded connection 238 configured to connect to corrugated conduit 232 with diameter 268. In this illustrative example, adapter 224 has threaded connection 242 configured to connect to corrugated conduit 234 with diameter 270. In some illustrative examples, diameter 268 is different from diameter 270. In some illustrative examples, although diameter 268 and diameter 270 are different, the locking features of adapter 222 and adapter 224 are the same.

In this illustrative example, threaded connection 248 is configured to connect to corrugated conduit 236. In this illustrative example, corrugated conduit 236 has diameter 272.

In some illustrative examples, all adapters of number of adapters 218 and number of adapters 220 have a same size locking feature configured to interface with manifold 202. In some illustrative examples, manifold 202 comprises anti-rotation features configured to restrict movement of number of adapters 218.

Manifold 202 is a two-piece body, variable size branch design that allows the ability to inspect, modify and, repair assembly without disassembly of other portions of the wire assembly. The illustrative examples allow for each branch to be standalone until reassembly with the manifold body. Non-threaded locking features allow for reduction or elimination of twisting for number of corrugated conduits 228 and number of corrugated conduits 230.

In some illustrative examples, manifold 202 comprises a clear two-piece body split design that utilizes a common size locking feature for all adapters to allow the ability to easily change size while maintaining existing body design. In some illustrative examples, the locking features take the form of a number of collars.

In some illustrative examples, each threaded adapter, number of adapters 218 and number of adapters 220, maintains a slot to allow fibers to be fed through without the need to disassemble fiber assembly. In some illustrative examples, the slot takes the form of a +/−0.1″ split.

In this illustrative example, a captive hardware design is provided to maintain hardware within manifold 202 in the event of hardware loosening. Captive fastener system 277 maintains captive fasteners 276 within manifold 202.

The illustrative examples can be used for any conductor and fiber cable running through conduit that has a split or junction. The illustrative examples can be used for test equipment that verifies operation of conductors and fiber cable. The illustrative examples can be used on aircraft, ships, commercial buildings, or other platforms that utilize corrugated conduits.

The illustrative examples allow for at least one of modification, inspection, or repair without disassembling the cable assembly from the connector to the Y adapter. Visual inspection of fiber in old manifold adapter area is not possible as material was not transparent nor allowed the ability to inspect easily.

The illustration of manufacturing environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, in some illustrative examples, manifold 202 can have more than two openings on first end 208. In other illustrative examples, manifold 202 can have more than one opening on second end 210. In some illustrative examples, threaded inserts 288 are optional.

As another example, captive fasteners 276 can be optional. In some illustrative examples, manifold 202 can be fastened together without captive fastener system 277. In some illustrative examples, when captive fasteners 276 are not utilized, expandable openings 278 are not present.

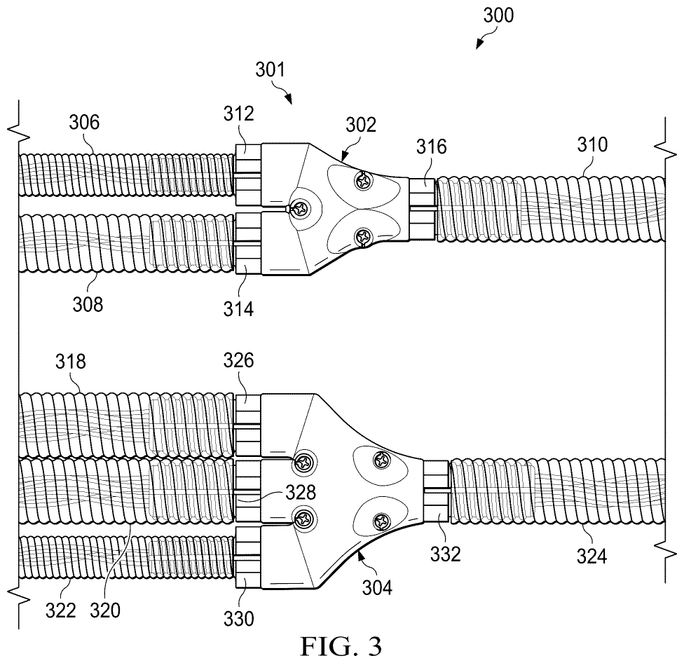

Turning now to FIG. 3, an illustration of fibers extending through corrugated conduits and manifolds is depicted in accordance with an illustrative embodiment. In view 300, manifold 302 and manifold 304 can be physical implementations of manifold 202 of FIG. 2. Manifold 302 connects two corrugated conduits on a first end of manifold 302 to a single corrugated conduit on a second end of manifold 302. Corrugated conduit 306 and corrugated conduit 308 are connected to a first end of manifold 302. Corrugated conduit 310 is connected to a second end of manifold 302. Manifold 302 may be referred to as a 2/1 manifold.

Manifold 304 connects three corrugated conduits on a first end of manifold 304 to a single corrugated conduit on a second end of manifold 304. Corrugated conduit 318, corrugated conduit 320, and corrugated conduit 322 are connected to a first end of manifold 304. Corrugated conduit 324 is connected to a second end of manifold 304. Manifold 304 can be referred to as a 3/1 manifold.

The manifolds are connected to the corrugated conduits by adapters. A number of adapters extend into the corrugated conduits and manifold 302. Adapter 312 connects corrugated conduit 306 to manifold 302. Adapter 314 connects corrugated conduit 308 to manifold 302. Adapter 316 connects corrugated conduit 310 to manifold 302. Adapter 312, adapter 314, and adapter 316 can be physical implementations of number of adapters 218 and number of adapters 220 of FIG. 2.

A number of adapters extend into the corrugated conduits and manifold 304. Adapter 326 connects corrugated conduit 318 to manifold 304. Adapter 328 connects corrugated conduit 320 to manifold 304. Adapter 330 connects corrugated conduit 322 to manifold 304. Adapter 332 connects corrugated conduit 324 to manifold 304. Adapter 326, adapter 328, adapter 330, and adapter 332 can be physical implementations of number of adapters 218 and number of adapters 220 of FIG. 2.

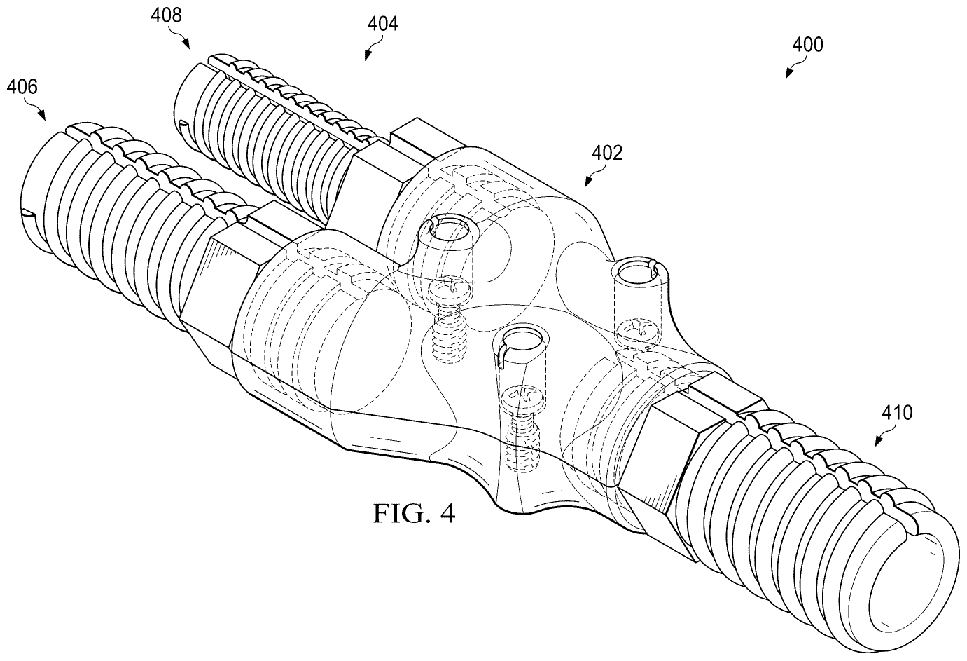

Turning now to FIG. 4, an illustration of an isometric view of a manifold and adapters is depicted in accordance with an illustrative embodiment. Manifold 402 in view 400 is a physical implementation of manifold 202 of FIG. 2. In some illustrative examples, manifold 402 is the same as manifold 302 of FIG. 3. Manifold 402 can be used within aircraft 100 to run wires, such as electrical wires or fiber optics. In some illustrative examples, manifold 402 can be a portion of maintenance equipment used for testing of components of aircraft 100.

Number of adapters 404 are connected to manifold 402. Number of adapters 404 includes adapter 406 and adapter 408 connected to manifold 402. Number of adapters 404 includes adapter 410 connected to manifold 402.

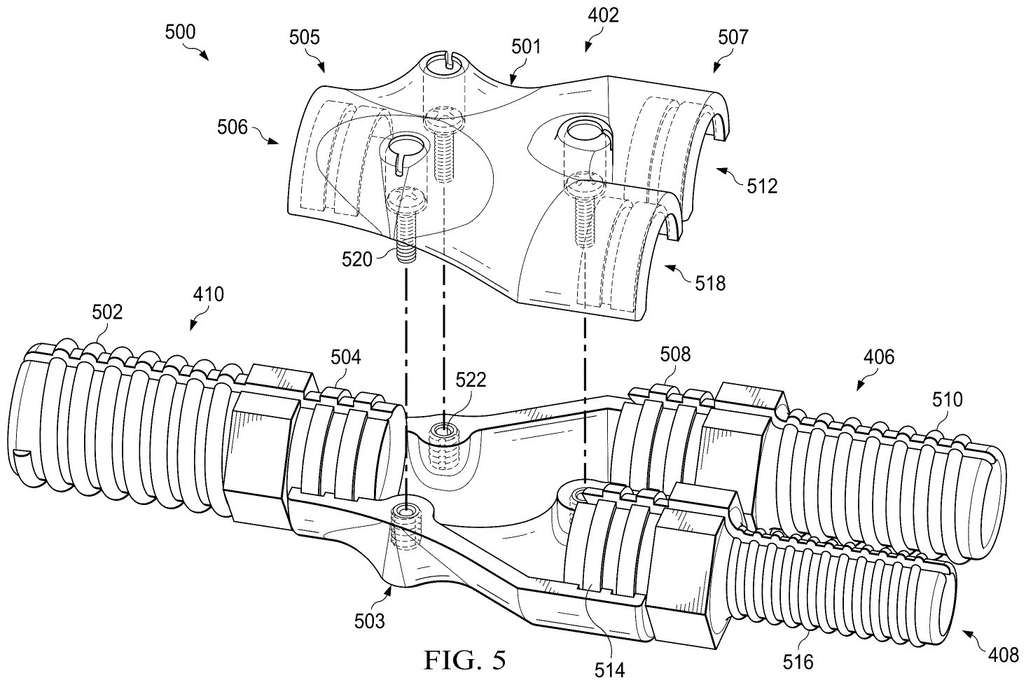

Turning now to FIG. 5, an illustration of a partially exploded side view of a manifold and adapters is depicted in accordance with an illustrative embodiment. View 500 is a partially exploded view of manifold 402. In view 500, manifold 402 is depicted as transparent for ease of explanation. Manifold 402 can be manufactured from any desirable material having any desirable color or opacity. In this illustrative example, manifold 402 comprises first half 501 and second half 503.

In view 500, number of adapters 404 is more clearly depicted. In this illustrative example, number of adapters 404 comprise more than one diameter. Each of number of adapters 404 has a same size connection for engaging with manifold 402. Each of number of adapters can be removed and replaced with a different adapter if a different diameter adapter is desired.

Adapter 410 comprises threaded connection 502 and locking feature 504. Locking feature 504 is non-threaded. In some illustrative examples, locking feature 504 can take another desired shape to retain adapter 410 within manifold 402 without threads. Locking feature 504 is the same as locking feature 508 and locking feature 514. When a different type of locking feature is used for adapter 410, all adapters for manifold 402 will have the same type of locking feature so that adapters are universal.

In this illustrative example, locking feature 504 takes the form of cylindrical protrusions. The cylindrical protrusions of locking feature 504 retain adapter 410 within opening 506 of manifold 402. In this illustrative example, opening 506 is on first end 505 of manifold 402. When manifold 402 is connected, adapter 406 and adapter 408 are connected to first end 505 of manifold 402. In this illustrative example, the locking features comprise a series of grooves. In these illustrative examples, each of the adapters have a same size locking feature configured to interface with manifold 402.

In this illustrative example, locking feature 508 takes the form of cylindrical protrusions. The cylindrical protrusions of locking feature 508 retain adapter 406 within opening 512 of manifold 402. In this illustrative example, opening 512 is on second end 507 of manifold 402. When manifold 402 is connected, adapter 410 is connected to second end 507 of manifold 402.

In this illustrative example, locking feature 514 takes the form of cylindrical protrusions. The cylindrical protrusions of locking feature 514 retain adapter 408 within opening 518 of manifold 402. In this illustrative example, the protrusions are not continuous. In this illustrative example, opening 518 is on second end 507 of manifold 402.

Adapter 406 comprises locking feature 508 and threaded connection 510. Threaded connection 502 and threaded connection 510 do not have the same diameter, but they could as the application demands. Adapter 408 comprises locking feature 514 and threaded connection 516. Threaded connection 516 has a smaller diameter than threaded connection 510 and threaded connection 502.

In this illustrative example, each of opening 506, opening 512, and opening 518 have locking features to interface with locking features of the adapters. The locking features of manifold 402 are operational when first half 501 and second half 503 are removably connected.

In this illustrative example, captive fasteners 520 are used to connect first half 501 to second half 503 of manifold 402. Captive fasteners 520 are restrained within channels of first half 501 of manifold 402. Captive fasteners 520 connect to threaded inserts 522 in second half 503. Although threaded inserts 522 are used in this illustrative example, in other structures, captive fasteners 520 can be connected into threads of second half 503.

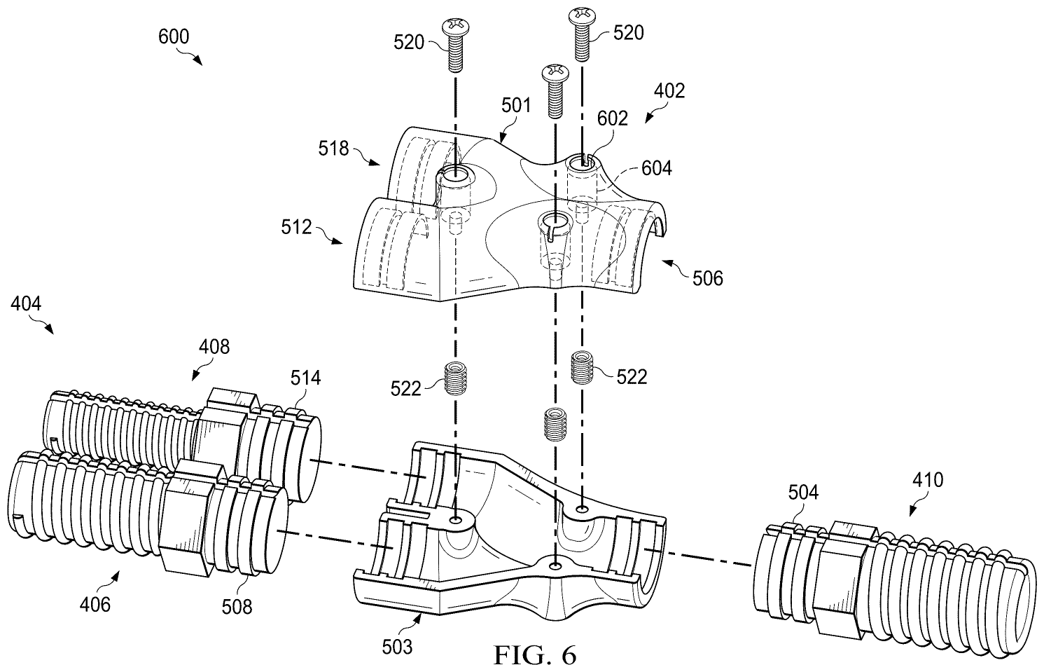

Turning now to FIG. 6, an illustration of an exploded isometric view of a manifold and adapters is depicted in accordance with an illustrative embodiment. In view 600, captive fasteners 520 are shown exploded out of expandable openings 602 in first half 501. To install captive fasteners 520, captive fasteners 520 are pressed into expandable openings 602. The shafts of captive fasteners 520 are sent through expandable openings 602 and into channels 604. The heads of captive fasteners 520 are sent through expandable openings 602 and then retained within channels 604.

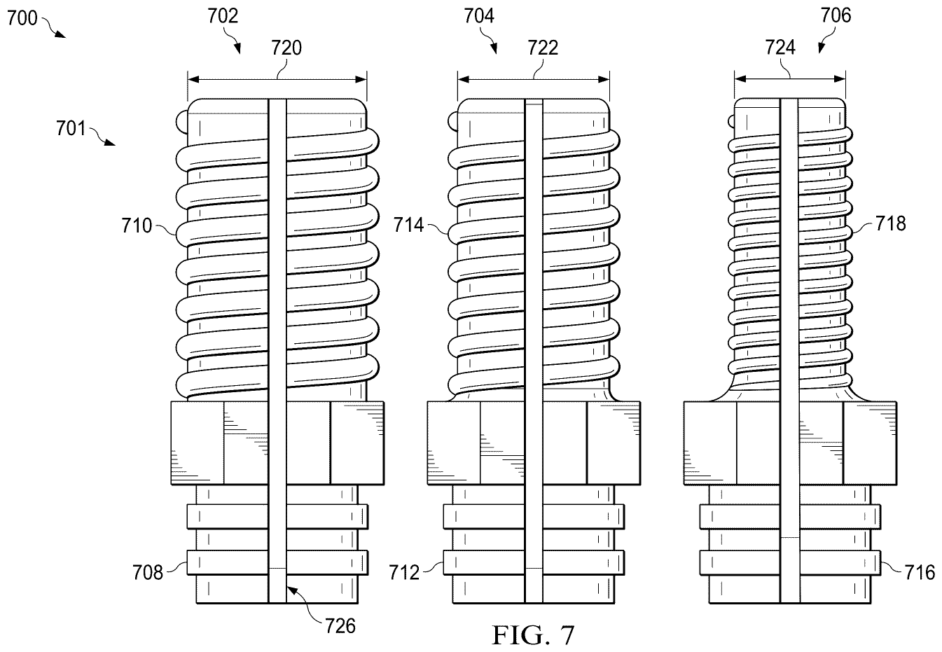

Turning now to FIG. 7, an illustration of a side view of multiple adapters is depicted in accordance with an illustrative embodiment. Adapters 701 of FIG. 7 can be a physical implementation of adapters for number of adapters 218 or number of adapters 220. In some illustrative examples, at least one adapter of adapters 701 can be used in fiber management system 301 in FIG. 3. In some illustrative examples, adapters 701 can be used in conjunction with manifold 402 of FIGS. 4-6.

In view 700, adapters 701 are aligned to more easily compare the components. Each of adapters 701 has a different design than each other of adapters 701. Adapters 701 include adapter 702, adapter 704, and adapter 706. Adapter 702 has locking feature 708 and threaded connection 710. Adapter 704 has locking feature 712 and threaded connection 714. Adapter 706 has locking feature 716 and threaded connection 718. Locking feature 708, locking feature 712, and locking feature 716 are each the same. Locking feature 708, locking feature 712, and locking feature 716 allow for adapters 701 to be interchangeable in a manifold. In some illustrative examples, locking feature 708, locking feature 712, and locking feature 716 are referred to as universal locking features.

Threaded connection 710, threaded connection 714, and threaded connection 718 are configured to connect to different diameters of corrugated conduits. As depicted, threaded connection 710 has a larger diameter and a thicker thread than threaded connection 714 and threaded connection 718. Threaded connection 710 has diameter 720. Diameter 720 is larger than diameter 722 and diameter 724. Adapter 702 is configured to connect to a corrugated conduit with a largest diameter. As depicted, threaded connection 714 has diameter 722 smaller than diameter 720. Threaded connection 718 has a smallest diameter and narrowest threads of adapters 701. Threaded connection 718 has diameter 724.

In this illustrative example, each of plurality of adapters 701 comprises a slot. In this illustrative example, adapter 702 comprises slot 726. Slot 726 can stop adapter 702 from rotating in a manifold. In some illustrative examples, slot 726 can act as a keying feature. Fibers extending through adapter 702 may twist if adapter 702 spins. Preventing spinning can maintain quality of the fibers. In some illustrative examples, slot 726 allows fibers to be inserted into the fiber management system.

Slot 726 can reduce compression on the adapter. Slot 726 can allow for a manifold to compress adapter 702 to hold adapter 702 within the manifold without undesirably damaging adapter 702.

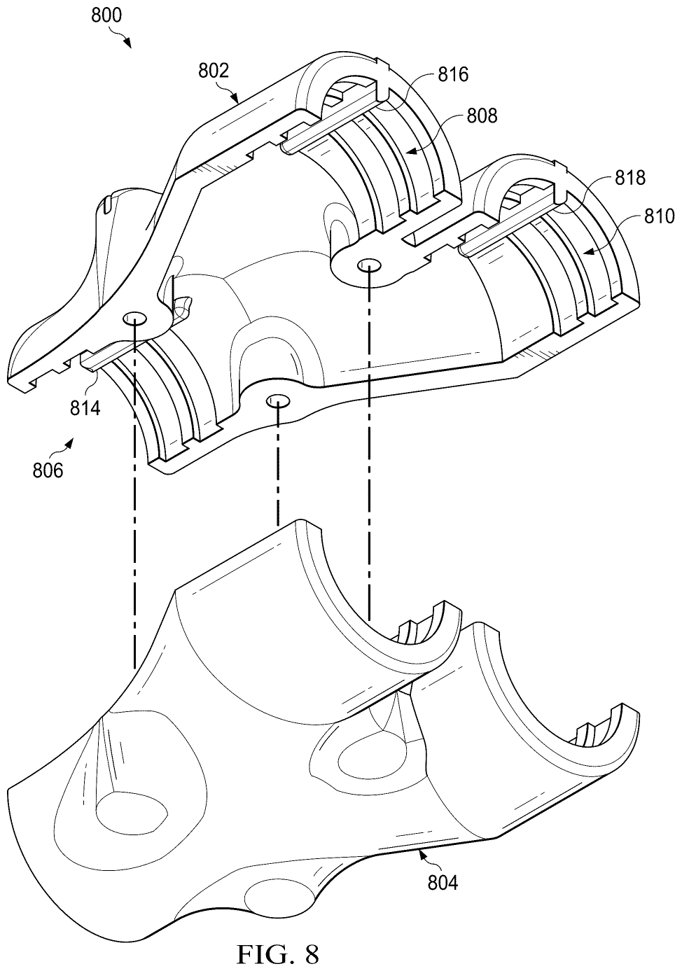

Turning now to FIG. 8, an illustration of a bottom view of a manifold with anti-rotation features is depicted in accordance with an illustrative embodiment. Manifold 800 is a physical implementation of manifold 202 of FIG. 2. In some illustrative examples, manifold 800 can be the same as manifold 302 of FIG. 3. Manifold 800 can be the same as manifold 402 of FIGS. 4-6. In some illustrative examples, manifold 800 can be used with adapters 701 of FIG. 7.

Manifold 800 comprises first half 802 and second half 804 removably connected to first half 802 to form a volume within manifold 800. Manifold 800 comprises a first number of openings on a first end to access the volume. In this illustrative example, the first number of openings comprises opening 806. Manifold 800 comprises a second number of openings on a second end to access the volume. In this illustrative example, the second number of openings comprises opening 808 and opening 810. Each of the openings has an anti-rotation feature. Opening 806 has anti-rotation feature 814. Opening 808 has anti-rotation feature 816. Opening 810 has anti-rotation feature 818.

Each anti-rotation feature can prevent rotation of a respective adapter and corrugated conduit. In some illustrative examples, each anti-rotation feature can act as a keying feature.

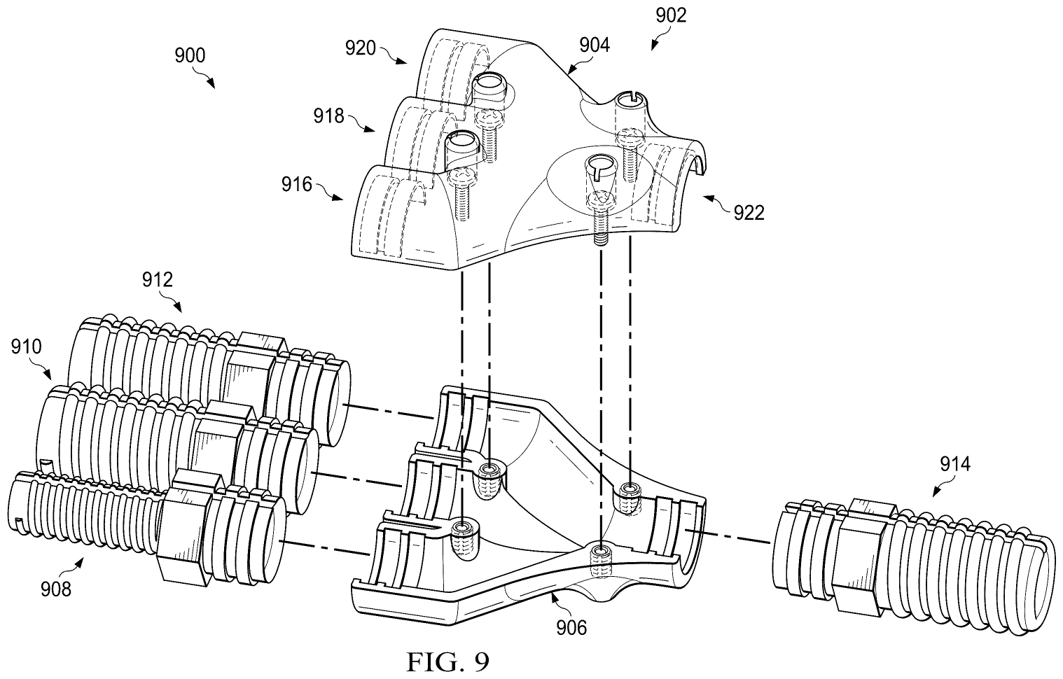

Turning now to FIG. 9, an illustration of an exploded isometric view of a manifold and adapters is depicted in accordance with an illustrative embodiment. Manifold 902 in view 900 is a physical implementation of manifold 202 of FIG. 2. In some illustrative examples, manifold 902 is the same as manifold 304 of FIG. 3. Manifold 902 can be used within aircraft 100 to run wires, such as electrical wires or fiber optics. In some illustrative examples, manifold 902 can be a portion of maintenance equipment used for testing of components of aircraft 100. Manifold 902 can be referred to as a 3/1 manifold.

Manifold 902 comprises first half 904 and second half 906. Separating first half 904 and second half 906 cleaves each of opening 916, opening 918, opening 920, and opening 922. A plurality of adapters can be used to connect a plurality of corrugated conduits to manifold 902. In this illustrative example, the plurality of adapters comprises adapter 908, adapter 910, adapter 912, and adapter 914. Each of the plurality of adapters is interchangeable due to the same locking features. Each adapter can be selected based on a size of a corrugated conduit.

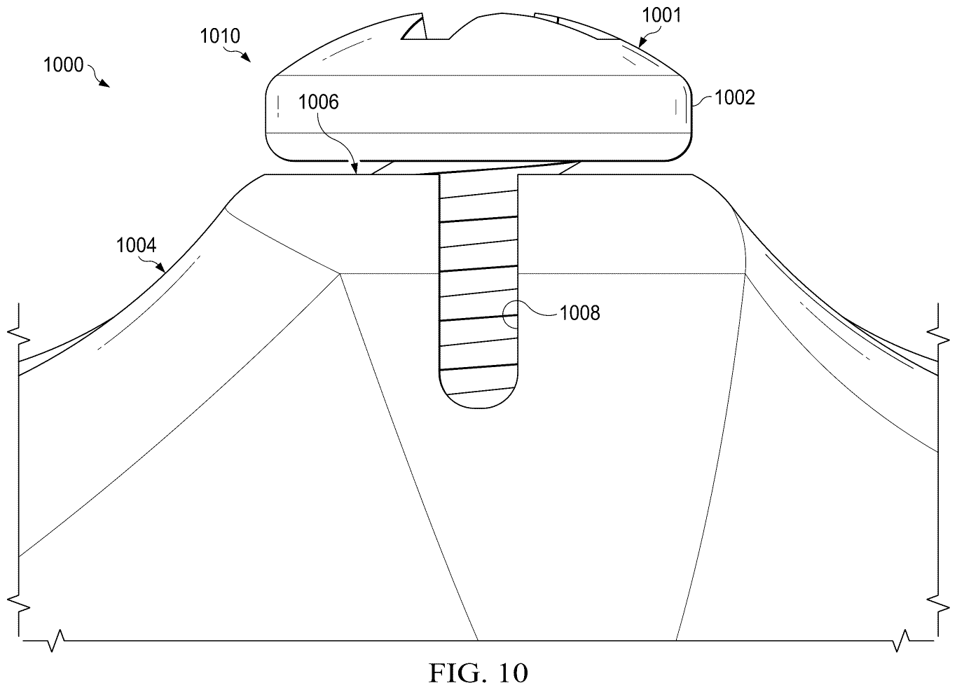

Turning now to FIG. 10, an illustration of a side view of a fastener prior to installation as a captive fastener is depicted in accordance with an illustrative embodiment. In some illustrative examples, fastener 1001 and structure 1004 can be components of aircraft 100 of FIG. 1. In some illustrative examples, structure 1004 can be a physical implementation of manifold 202 of FIG. 2. In some illustrative examples, structure 1004 can be a portion of manifold 402 of FIGS. 4-6. In some illustrative examples, structure 1004 can be a portion of manifold 800 of FIG. 8. In some illustrative examples, structure 1004 can be a portion of manifold 902 of FIG. 9.

View 1000 is a view of fastener 1001 prior to being installed in structure 1004 as a captive fastener. In view 1000, a shank portion of fastener 1001 extends into structure 1004. Head 1002 of fastener 1001 is outside of structure 1004.

The shank portion of fastener 1001 is extending through expandable opening 1006. Expandable opening 1006 is configured to expand to allow head 1002 of fastener 1001 through expandable opening 1006. Slot 1008 in structure 1004 allows for expansion of expandable opening 1006 to allow entry of head 1002 of fastener 1001.

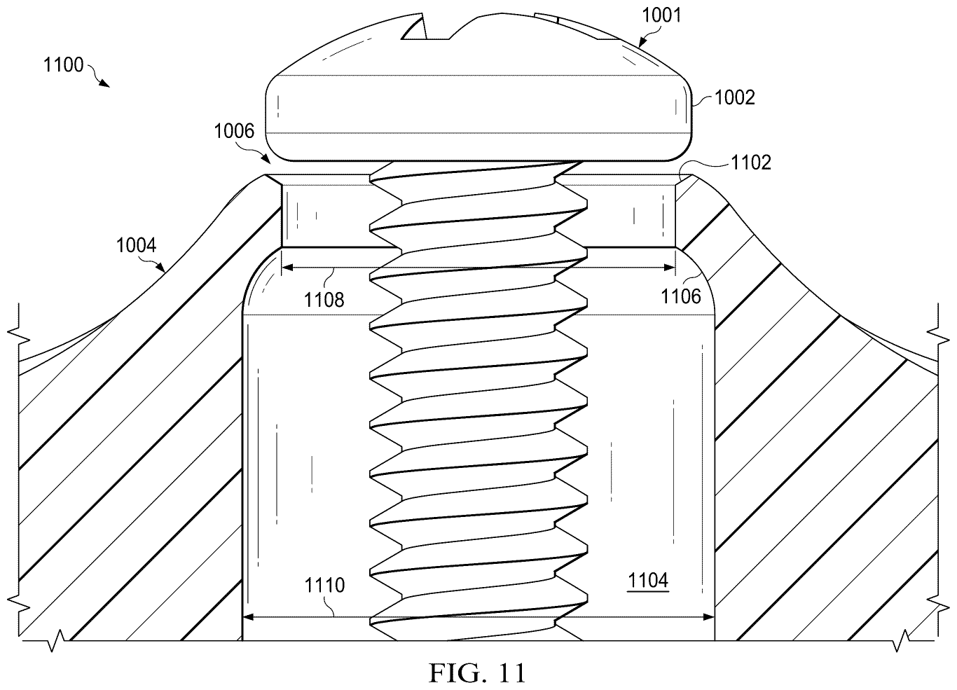

Turning now to FIG. 11, an illustration of a cross-sectional view of a fastener prior to installation as a captive fastener in a channel is depicted in accordance with an illustrative embodiment. View 1100 is a cross-sectional view of structure 1004. In view 1100, chamfer 1102 of expandable opening 1006 is visible. Chamfer 1102 allows for easier entry of head 1002 of fastener 1001.

Channel 1104 in structure 1004 is visible in view 1100. Channel 1104 comprises edge blend 1106 configured to retain head 1002 of fastener 1001. Edge blend 1106 can be referred to as an upper inner edge blend. Edge blend 1106 improves captive function while allowing for intentional removal of fasteners for replacement. Edge blend 1106 within channel 1104 leads towards expandable opening 1006.

Expandable opening 1006 has initial diameter 1108 and is connected to channel 1104. Channel 1104 has internal diameter 1110 larger than initial diameter 1108. Channel also has an exit diameter (not depicted) configured to retain head 1002 of fastener 1001 inside channel 1104. Internal diameter 1110 of channel 1104 is configured to allow movement of head 1002 within channel 1104.

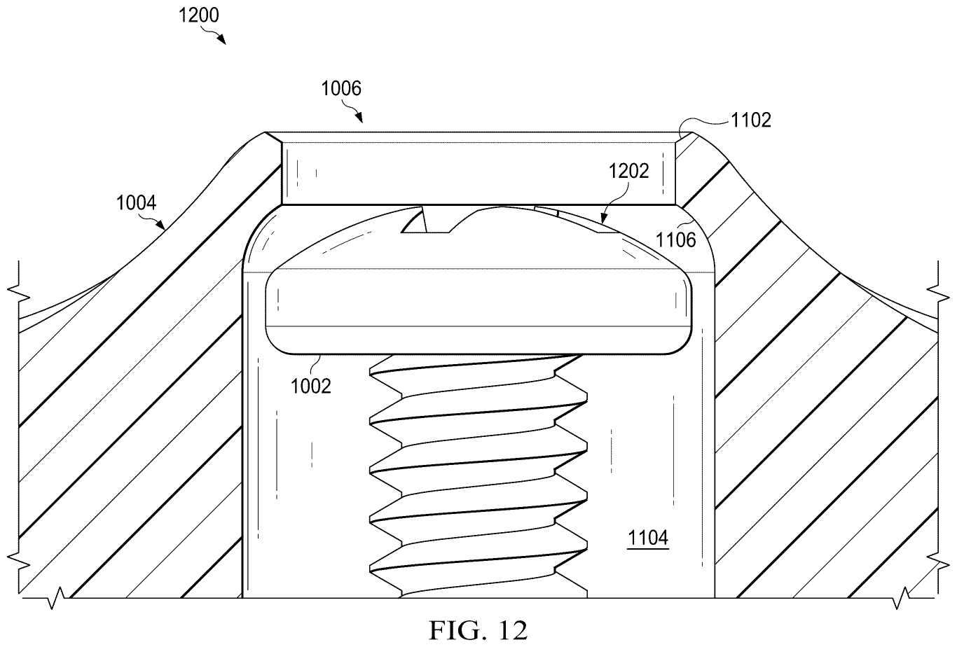

Turning now to FIG. 12, an illustration of a cross-sectional view of a captive fastener within a channel is depicted in accordance with an illustrative embodiment. In view 1200, fastener 1001 has been sent through expandable opening 1006 and into channel 1104. In view 1200, fastener 1001 is referred to as captive fastener 1202. Head 1002 of fastener 1001 is restrained within channel 1104.

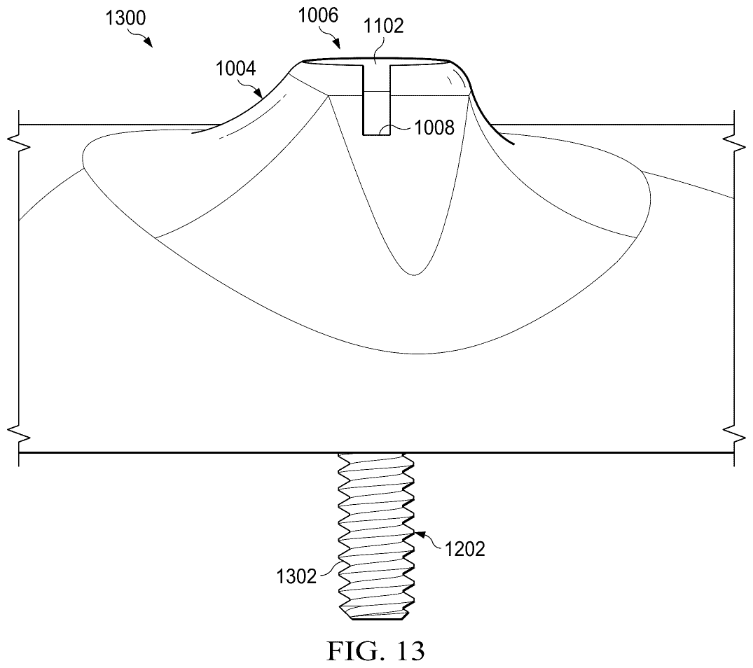

Turning now to FIG. 13, an illustration of a view of a structure with a captive fastener within a channel is depicted in accordance with an illustrative embodiment. In view 1300, shaft 1302 of captive fastener 1202 extends outside of structure 1004. Head 1002 of captive fastener 1202 is not visible in view 1300. In view 1300, head 1002 of captive fastener 1202 is retained within channel 1104. Captive fastener 1202 can be used to join structure 1004 to another structure.

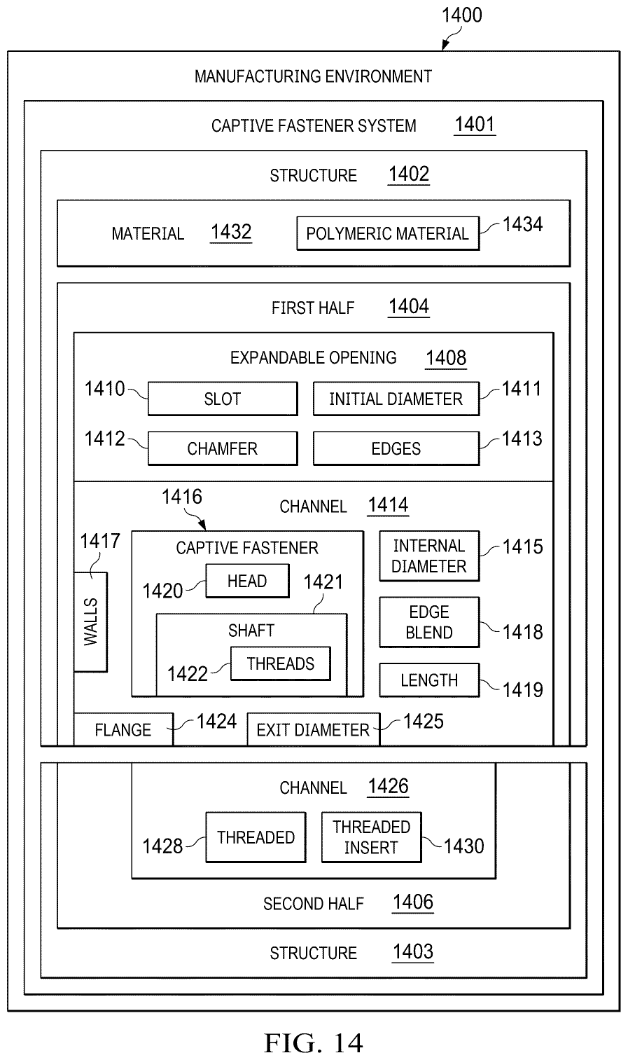

Turning now to FIG. 14, an illustration of a block diagram of a manufacturing environment is depicted in accordance with an illustrative embodiment. Captive fastener system 1401 can be used in aircraft 100 of FIG. 1. Captive fastener system 1401 can be used in fiber management system 201 of FIG. 2. Captive fastener system 1401 can include captive fasteners 276 of FIG. 2. Captive fastener system 1401 can be used in manifold 302 or manifold 304 of FIG. 3. Captive fastener system 1401 can be used in manifold 402 of FIGS. 4-6. Captive fastener system 1401 can be used in manifold 800 of FIG. 8. Captive fastener system 1401 can be used in manifold 902 of FIG. 9. Captive fastener system 1401 can comprise fastener 1001 and channel 1104 of structure 1004 in FIGS. 10-13.

Captive fastener system 1401 can be assembled in manufacturing environment 1400. Captive fastener system 1401 comprises channel 1414 and expandable opening 1408 with initial diameter 1411 connected to channel 1414. Channel 1414 has internal diameter 1415 larger than initial diameter 1411 and exit diameter 1425 configured to retain head 1420 of captive fastener 1416 inside the channel 1414.

Features of channel 1414 and expandable opening 1408 are configured to allow controlled insertion of captive fastener 1416 and intentional removal of captive fastener 1416. Features of channel 1414 and expandable opening 1408 are configured to retain captive fastener 1416 within channel 1414. Retaining captive fastener 1416 within channel 1414 reduces or eliminates foreign object debris (FOD).

In some illustrative examples, the features of channel 1414 comprise edge blend 1418. In some illustrative examples, edge blend 1418 is present within channel 1414 leading towards expandable opening 1408. In some illustrative examples, captive fastener system 1401 comprises edge blend 1418 within channel 1414 on an opposite end from exit diameter 1425. In some illustrative examples, edge blend 1418 retains head 1420 within channel 1414. In some illustrative examples, edge blend 1418 is configured to aid in controlled removal of captive fastener 1416 from channel 1414. In some illustrative examples, edge blend 1418 is configured based on a size and shape of head 1420.

In some illustrative examples, the features of expandable opening 1408 comprise chamfer 1412. In some illustrative examples, chamfer 1412 on expandable opening 1408 is configured to allow for insertion of head 1420 into channel 1414.

In some illustrative examples, the features of expandable opening 1408 comprise slot 1410. In some illustrative examples, slot 1410 is in structure 1402 extending from expandable opening 1408 towards channel 1414. In some illustrative examples, slot 1410 allows for expandable opening 1408 to increase from initial diameter 1411 to a size large enough to allow head 1420 to enter channel 1414.

Channel 1414 has length 1419. In some illustrative examples, length 1419 of channel 1414 is sufficient to fully house captive fastener 1416 including shaft 1421 and head 1420. In some illustrative examples, length 1419 of channel 1414 is sufficiently long so that threads 1422 are not protruding from structure 1402. In some illustrative examples, structure 1402 can be described as first half 1404 of an assembly such as a manifold. Length 1419 of channel 1414 can enable mating of structure 1402 and structure 1403 without potential foreign object debris. Length 1419 of channel 1414 can enable mating of structure 1402 and structure 1403 without captive fastener 1416 inadvertently damaging structure 1403.

Structure 1402 is formed of material 1432 configured to allow for insertion and removal of captive fastener 1416 without damage to structure 1402. In some illustrative examples, material 1432 is configured to provide sufficient flexibility to allow for insertion and removal of captive fastener 1416 without damage to structure 1402. In some illustrative examples, material 1432 comprises polymeric material 1434. In some illustrative examples, edges 1413 of expandable opening 1408 and walls 1417 of the channel 1414 are formed by polymeric material 1434.

Internal diameter 1415 of the channel is configured to allow movement of the head 1420 within channel 1414. Exit diameter 1425 is smaller than internal diameter 1415. Exit diameter 1425 is formed by any desirable feature of channel 1414. In some illustrative examples, exit diameter 1425 is defined by flange 1424 extending inwardly in channel 1414.

In some illustrative examples, captive fastener system 1401 comprises channel 1414 and captive fastener 1416 with head 1420 positioned within channel 1414. Channel 1414 has expandable opening 1408 configured to allow entry of head 1420 of captive fastener 1416 and limit exit of head 1420 of captive fastener 1416 and exit diameter 1425 configured to allow shaft 1421 of captive fastener 1416 to extend through exit diameter 1425 and prevent exit of head 1420 of captive fastener 1416.

Structure 1402 can be joined to structure 1403 by captive fastener 1416. Structure 1403 comprises channel 1426 that receives captive fastener 1416. In some illustrative examples channel 1426 is threaded to engage with threads 1422 of captive fastener 1416. In other illustrative examples, threaded insert 1430 is present in channel 1426. When threaded insert 1430 is present in channel 1426, threaded insert 1430 is configured to engage with threads 1422 of captive fastener 1416. In some illustrative examples, structure 1403 can be described as second half 1406 of an assembly.

The illustration of manufacturing environment 1400 in FIG. 14 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, structure 1403 can be formed of the same material as material 1432 of structure 1402. In other illustrative examples, structure 1403 can be formed of a different material as material 1432 of structure 1402.

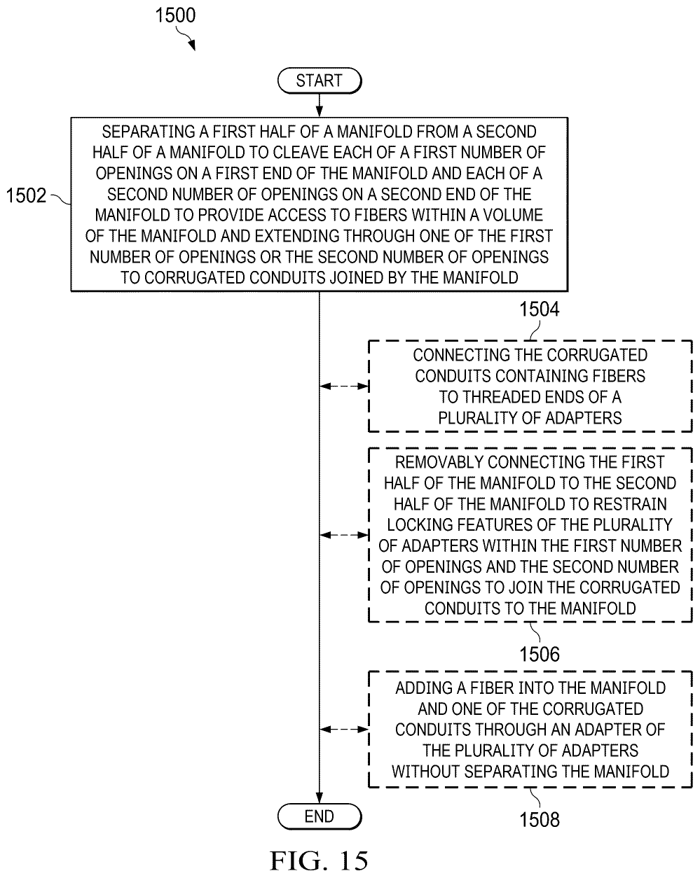

Turning now to FIG. 15, a flowchart of a method of managing fibers is depicted in accordance with an illustrative embodiment. Method 1500 can be performed to manage fibers of aircraft 100 of FIG. 1. Method 1500 can be performed to manage optical fibers 274 of FIG. 2. Method 1500 can be performed using fiber management system 201 of FIG. 2. Method 1500 can be performed using fiber management system 301 of FIG. 3. Method 1500 can be performed using manifold 402 of FIGS. 4-6. Method 1500 can be performed using adapters 701 of FIG. 7. Method 1500 can be performed using manifold 800 of FIG. 8. Method 1500 can be performed using manifold 902 of FIG. 9. Captive fastener system 1010 of FIGS. 10-13 can be used in method 1500 to connect or disconnect the manifold. Captive fastener system 1401 of FIG. 14 can be used in method 1500 to connect or disconnect the manifold.

Method 1500 separates a first half of a manifold from a second half of a manifold to cleave each of a first number of openings on a first end of the manifold and each of a second number of openings on a second end of the manifold to provide access to fibers within a volume of the manifold and extending through one of the first number of openings or the second number of openings to corrugated conduits joined by the manifold (operation 1502). Afterwards, method 1500 terminates.

In some illustrative examples, method 1500 connects the corrugated conduits containing fibers to threaded ends of a plurality of adapters (operation 1504). In some illustrative examples, method 1500 removably connects the first half of the manifold to the second half of the manifold to restrain locking features of the plurality of adapters within the first number of openings and the second number of openings to join the corrugated conduits to the manifold (operation 1506). By the locking features being non-threaded, the corrugated conduits are not twisted connecting the plurality of adapters to the manifold.

In some illustrative examples, method 1500 adds a fiber into the manifold and one of the corrugated conduits through an adapter of the plurality of adapters without separating the manifold (operation 1508). In some illustrative examples, a slot within the adapter allows for insertion of a fiber through the adapter without separating the manifold. In some illustrative examples, insertion of the fiber can be viewed through a transparent or translucent material of the manifold.

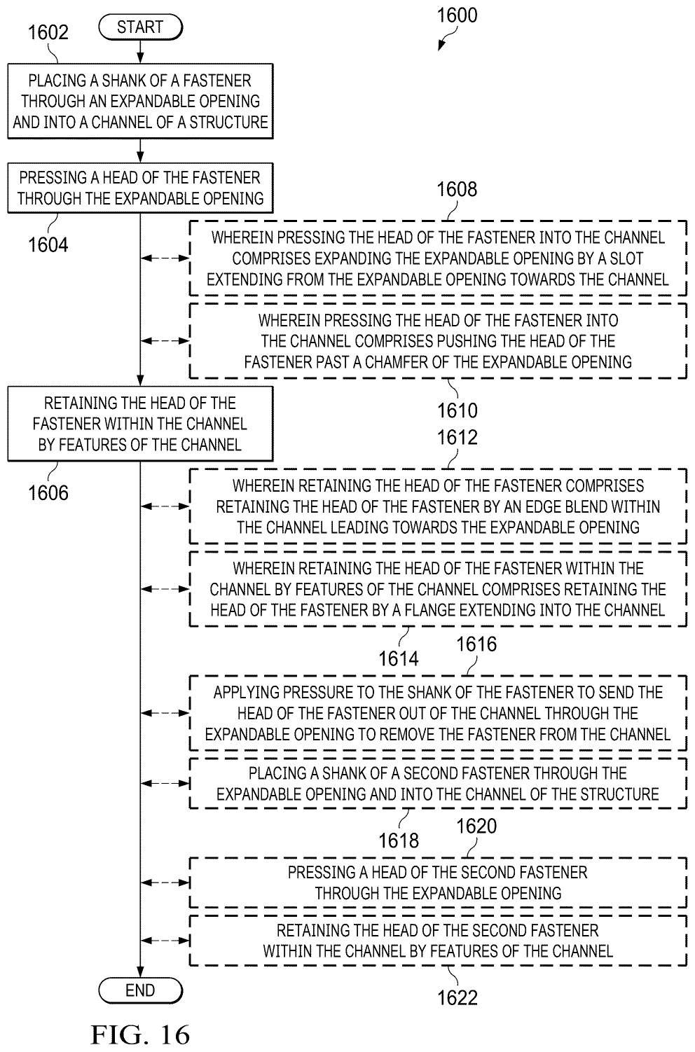

Turning now to FIG. 16, a flowchart of a method of installing a captive fastener is depicted in accordance with an illustrative embodiment. Method 1600 can be performed to install a captive fastener in aircraft 100 of FIG. 1. Method 1600 can be performed to install captive fasteners 276 of FIG. 2. Method 1600 can be performed to install captive fasteners in fiber management system 301 of FIG. 3. Method 1600 can be performed to install captive fasteners in manifold 402 of FIGS. 4-6. Method 1600 can be performed to install captive fasteners in manifold 800 of FIG. 8. Method 1600 can be performed using manifold 902 of FIG. 9. Captive fastener system 1010 of FIGS. 10-13 can be used in method 1600 to connect or disconnect the manifold. Captive fastener system 1401 of FIG. 14 can be used in method 1600 to connect or disconnect the manifold.

Method 1600 places a shank of a fastener through an expandable opening and into a channel of a structure (operation 1602). Method 1600 presses a head of the fastener through the expandable opening (operation 1604). Method 1600 retains the head of the fastener within the channel by features of the channel (operation 1606). Afterwards, method 1600 terminates.

In some illustrative examples, pressing the head of the fastener into the channel comprises expanding the expandable opening by a slot extending from the expandable opening towards the channel (operation 1608). In some illustrative examples, pressing the head of the fastener into the channel comprises pushing the head of the fastener past a chamfer of the expandable opening (operation 1610). In some illustrative examples, the chamfer aids in inserting the head through the expandable opening.

In some illustrative examples, retaining the head of the fastener comprises retaining the head of the fastener by an edge blend within the channel leading towards the expandable opening (operation 1612). In some illustrative examples, retaining the head of the fastener within the channel by features of the channel comprises retaining the head of the fastener by a flange extending into the channel (operation 1614).

In some illustrative examples, method 1600 applies pressure to the shank of the fastener to send the head of the fastener out of the channel through the expandable opening to remove the fastener from the channel (operation 1616). In some illustrative examples, method 1600 places a shank of a second fastener through the expandable opening and into the channel of the structure (operation 1618). In some illustrative examples, method 1600 presses a head of the second fastener through the expandable opening (operation 1620).

In some illustrative examples, method 1600 retains the head of the second fastener within the channel by features of the channel (operation 1622). In some illustrative examples, the features of the channels can include at least one of a flange forming an exit diameter. In some illustrative examples, the features of the channels can include an edge blend.

As used herein, the phrase “at least one of,” when used with a list of items, means different combinations of one or more of the listed items may be used and only one of each item in the list may be needed. For example, “at least one of item A, item B, or item C,” may include, without limitation, item A, item A and item B, or item B. This example also may include item A, item B, and item C, or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional. For example, operation 1504 through operation 1508 may be optional. As another example, operation 1608 through operation 1622 may be optional.

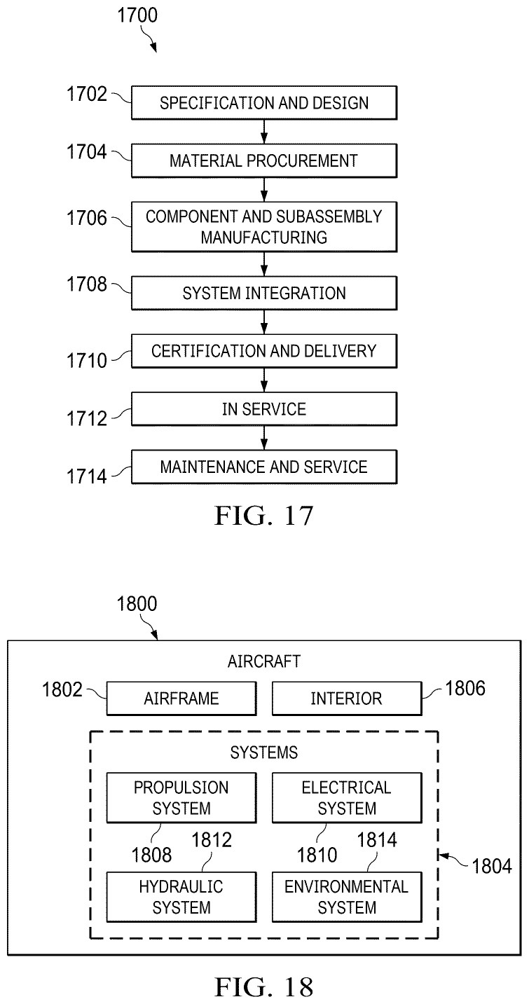

Illustrative embodiments of the present disclosure may be described in the context of aircraft manufacturing and service method 1700 as shown in FIG. 17 and aircraft 1800 as shown in FIG. 18. Turning first to FIG. 17, an illustration of an aircraft manufacturing and service method in a form of a block diagram is depicted in accordance with an illustrative embodiment. During pre-production, aircraft manufacturing and service method 1700 may include specification and design 1702 of aircraft 1800 in FIG. 18 and material procurement 1704.

During production, component and subassembly manufacturing 1706 and system integration 1708 of aircraft 1800 takes place. Thereafter, aircraft 1800 may go through certification and delivery 1710 in order to be placed in service 1712. While in service 1712 by a customer, aircraft 1800 is scheduled for routine maintenance and service 1714, which may include modification, reconfiguration, refurbishment, or other maintenance and service.

Each of the processes of aircraft manufacturing and service method 1700 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 18, an illustration of an aircraft in a form of a block diagram is depicted in which an illustrative embodiment may be implemented. In this example, aircraft 1800 is produced by aircraft manufacturing and service method 1700 of FIG. 17 and may include airframe 1802 with plurality of systems 1804 and interior 1806. Examples of systems 1804 include one or more of propulsion system 1808, electrical system 1810, hydraulic system 1812, and environmental system 1814. Any number of other systems may be included.

Apparatuses and methods embodied herein may be employed during at least one of the stages of aircraft manufacturing and service method 1700. One or more illustrative embodiments may be manufactured or used during at least one of component and subassembly manufacturing 1706, system integration 1708, in service 1712, or maintenance and service 1714 of FIG. 17.

The illustrative examples recognize and take into account one or more considerations. The illustrative examples recognize and take into account that wire assemblies and fiber optic assemblies are used to deliver electricity and data in platforms. The wire assemblies can include long stretches of tubing arranged in branches and connections between the branches.

The illustrative examples recognize and take into account that wire assembly uses multiple fabricators and labor hours to twist long stretches (30 ft+/−) of tubing for installing each branch for initial fabrication. Current designs are disassembled entirely to add or modify tubing count or size. Modifying or repairing fiber cable assemblies using current fabrication techniques can involve undesirable amounts of time and resources due to the complete disassembly from connectors to current manifolds.

The illustrative examples recognize and take into account that it would be desirable to have a method and apparatus to enable repair or redesign of a fiber or wire assembly without complete disassembly.

The illustrative examples present a manifold for connecting corrugated conduits. The illustrative examples present fiber management systems and methods of managing fibers. A fiber tubing manifold adapter is a multipiece variable input/output component that allows the fabrication and repair of fiber cables to be built up pre and post termination of the connectors. The illustrative examples can be utilized with a plurality of sizes of tubing. The illustrative examples allow for installation of fibers/wires after pin & socket termination of connector.

The illustrative examples also present a captive fastener system. The captive fastener system design features a tapered variable size opening that accepts mounting hardware during installation while keeping hardware captive upon rework. The captive fastener hardware designs eliminate potential FOD due to loose fasteners.

The illustrative examples allow for inspection, modification, and repair of fiber assemblies without completely disassembling the cable assembly from connector to the Y adapter. In some illustrative examples, the manifold enables visual inspection without disassembly of the manifold. In some illustrative examples, visual inspection can be performed when the manifold is at least one of transparent, nearly transparent, or translucent.

In some illustrative examples, the manifold provides the ability to add additional fiber and branches while keeping the remaining assembly intact. For example, when going from 2 branches to 3 branches, to add or modify tubing count or size the modular multi size and variable input/output design that maintains the existing parts allowing for the most adaptable solution.

The illustrative examples save the labor time for fabrication, modification and repair. The illustrative examples also increase quality by reducing the chance of damaged product. The illustrative examples reduce or eliminate the twisting of outer conduit tubing.

The illustrative examples are directed to a fiber tubing manifold having a multipiece variable input/output component which allows the fabrication and repair of fiber cables to be built up pre and post termination of the connectors. The current design is not constrained by size of tubing and installation of product is not limited to before pin & socket termination of connector. The illustrative examples include a modular manifold having a two-piece body and variable size branches that allow the ability to inspect, modify, and repair assembly without disassembly anywhere else in the system. The illustrative examples eliminate the twisting of tubing to allow each branch to be standalone until reassembly with the manifold body.

The captive fastener design maintains the fastener within the manifold in the event that the fastener becomes loose during installation or rework. Captive fastener design can be used on a multitude of pieces to be connected together.

The illustrative examples can be used with any conductor and fiber cables running through a corrugated conduit that includes a split or junction. The illustrative examples are suitable for applications with weight constraints where lightweight tubing is used. The illustrative examples can be used in aircraft, ships, buildings, spacecraft, ergonomics, or other fields in which weight constraints are a concern.

The description of the different illustrative embodiments has been presented for purposes of illustration and description and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A captive fastener system comprising:
an expandable opening with an initial diameter connected to a channel; and
the channel, wherein the channel has an internal diameter larger than the initial diameter and an exit diameter configured to retain a head of a fastener inside the channel.

2. The captive fastener system of claim 1 further comprising:
an edge blend within the channel leading towards the expandable opening.

3. The captive fastener system of claim 1 further comprising:
a chamfer on the expandable opening.

4. The captive fastener system of claim 1 further comprising:
a slot extending from the expandable opening towards the channel.

5. The captive fastener system of claim 1, wherein the exit diameter is defined by a flange extending inwardly in the channel.

6. The captive fastener system of claim 1, wherein edges of the expandable opening and walls of the channel are formed by a polymeric material.

7. A method of installing a captive fastener comprising:
placing a shank of a fastener through an expandable opening and into a channel of a structure;
pressing a head of the fastener through the expandable opening; and
retaining the head of the fastener within the channel by features of the channel.

8. The method of claim 7, wherein pressing the head of the fastener into the channel comprises expanding the expandable opening by a slot extending from the expandable opening towards the channel.

9. The method of claim 7, wherein pressing the head of the fastener into the channel comprises pushing the head of the fastener past a chamfer of the expandable opening.

10. The method of claim 7, wherein retaining the head of the fastener comprises retaining the head of the fastener by an edge blend within the channel leading towards the expandable opening.

11. The method of claim 7, wherein retaining the head of the fastener within the channel by features of the channel comprises retaining the head of the fastener by a flange extending into the channel.

12. The method of claim 7 further comprising:
applying pressure to the shank of the fastener to send the head of the fastener out of the channel through the expandable opening to remove the fastener from the channel.

13. The method of claim 12 further comprising:
placing a shank of a second fastener through the expandable opening and into the channel of the structure;
pressing a head of the second fastener through the expandable opening; and
retaining the head of the second fastener within the channel by features of the channel.

14. A captive fastener system comprising:
a fastener with a head positioned within a channel; and
the channel, wherein the channel has an expandable opening configured to allow entry of the head of the fastener and limit exit of the head of the fastener and an exit diameter configured to allow a shaft of the fastener to extend through the exit diameter and prevent exit of the head of the fastener.

15. The captive fastener system of claim 14 further comprising:
an edge blend within the channel on an opposite end from the exit diameter.

16. The captive fastener system of claim 14 further comprising:
a chamfer on the expandable opening.

17. The captive fastener system of claim 14 further comprising:
a slot extending from the expandable opening into the channel.

18. The captive fastener system of claim 14, wherein the exit diameter is defined by a flange extending inwardly in the channel.

19. The captive fastener system of claim 14, wherein an internal diameter of the channel is configured to allow movement of the head within the channel.

20. The captive fastener system of claim 14, wherein edges of the expandable opening and walls of the channel are formed by a polymeric material.
